(19) United States
(12) Patent Application Publication
(10) Pub. No.: US 2009/0108595 A1
(43) Pub. Date: Apr. 30, 2009

(54) Latching Mechanisms for Storage Containers

(75) Inventor: Kevin De Vries, Monroe, IA (US)

Correspondence Address: DINSMORE & SHOHL, LLP, 1900 CHEMED CENTER, 255 EAST FIFTH STREET, CINCINNATI, OH, 45202, US

(73) Assignee: DEE ZEE INC., Des Moines, IA (US)

(21) Appl. No.: 11/925,421

(22) Filed: Oct. 26, 2007

(51) Int. Cl. E05C 1/08

(52) U.S. Cl. 292/215; 292/214

(57) ABSTRACT

A latching mechanism for a storage container having multiple independent and dependent modes of operation may include a first actuation mechanism and a second actuation mechanism. Each actuation mechanism may include a cam that is extendable, retractable and rotatable with respect to the actuation mechanism. The latching mechanism may also include at least one latch receiving assembly for releasably receiving a latch pin. The latch receiving assembly may be in operable communication with a rotor that actuates the latch receiving assembly. The latch receiving assembly may be in operable communication with the first actuation mechanism and the second actuation mechanism via at least one actuation rod pivotally attached to the rotor. Independent and dependent modes of operation of the latching mechanism may be selected by rotating, extending, and retracting the cams of the first actuation mechanism and the second actuation mechanism.

### BACKGROUND OF THE INVENTION

The present invention generally relates to latch mechanisms, and more specifically, to latch mechanisms which may be used to latch vehicle storage containers.

Storage containers, such as tool boxes for use in conjunction with vehicles, typically have a hinged lid with a centrally positioned latching mechanism. Actuation mechanisms located on the left and right sides of the tool box are connected to the latching mechanism by rods which facilitate actuation of the latching mechanism from the driver's and passenger's sides of the tool box. In existing latch designs the first and second actuation mechanisms operate independently, meaning each actuation mechanism must be locked or unlocked separately. This requires the operator to move from one side of the vehicle (and tool box) to the other in order to unlock/lock both mechanisms.

Accordingly, a need exists for latching mechanisms for storage containers in which the individual actuation mechanisms can be locked dependently, such that both actuation mechanisms can be controlled from a single side, or independently, such that both actuation mechanisms can be separately locked.

### SUMMARY OF THE INVENTION

The present invention may include a latching mechanism for a storage container. The latching mechanism may include a first actuation mechanism and a second actuation mechanism in selective communication with each other. The latching mechanism may also include at least one latch receiving assembly configured to receive a latch pin and a rotor. The latch receiving assembly may comprise a rotor for actuating the at least one latch receiving assembly. The at least one latch receiving assembly may be in selective communication with the first actuation mechanism and the second actuation mechanism such that the first actuation mechanism and the second actuation mechanism each comprise an unengaged position, an independent engaged position, and a dependent engaged position relative to the at least one latch receiving assembly. The first actuation mechanism and the second actuation mechanism may be placed in different combinations of unengaged, independent engaged, and dependent engaged positions to facilitate actuating the latching mechanism with both the first and second actuation mechanisms (both actuation mechanisms are unlocked), either the first or the second actuation mechanism (one actuation mechanism is locked, the other is unlocked), or neither of the first and second actuation mechanisms (both actuation mechanisms are locked).

The present invention may include a latching mechanism for a storage container. The latching mechanism may include a first actuation mechanism and a second actuation mechanism oriented in opposition to one another. The first actuation mechanism may include a first cam and the second actuation mechanism may include a second cam. The first cam and the second cam are extendable, retractable and rotatable with respect to each of the first and second actuation mechanisms. The latching mechanism may also include at least one latch receiving assembly for releasably receiving a latch pin. The latch receiving assembly may be in operable communication with a rotor that actuates the latch receiving assembly. The latch receiving assembly may be disposed between the first actuation mechanism and the second actuation mechanism. The first actuation mechanism may be in mechanical communication with the latch receiving assembly by a first actuation rod extending between the first cam and the rotor. The second actuation mechanism may be in mechanical communication with the latch receiving assembly by a second actuation rod extending between the second cam and the rotor. A mode of operation of the latching mechanism may be determined by the position of the first cam relative to the first actuation rod and the position of the second cam relative to the second actuation rod.

In another exemplary embodiment, the present invention may include a latching mechanism for a storage container. The latching mechanism may include a first actuation mechanism and a second actuation mechanism oriented in parallel to one another. The first actuation mechanism may include a first cam and the second actuation mechanism may include a second cam. The first cam and the second cam are extendable, retractable and rotatable with respect to each of the first and second actuation mechanisms. The latching mechanism may include at least one latch receiving assembly for releasably receiving a latch pin. The at least one latch receiving assembly may include a rotor for actuating the first latch receiving assembly. An actuation rod may be pivotally attached to the rotor of the at least one latch receiving assembly. A first actuation lever may be in mechanical communication with the actuation rod and positioned proximate the first cam. A second actuation lever may be in mechanical communication with the actuation rod and positioned proximate the second cam. A mode of operation of the latching mechanism may be determined by the position of the first cam relative to the first actuation lever and the position of the second cam relative to the second actuation lever.

In yet another exemplary embodiment, the present invention may include a storage container. The storage container may include a first portion having a latching mechanism and a second portion having at least one latch pin. The first portion of the storage container and the second portion of the storage container may be attached to each other such that the storage container has an open position and a closed position. The latching mechanism of the first portion of the container may include a first actuation mechanism and a second actuation mechanism in selective communication with each other. The latching mechanism may also include at least one latch receiving assembly configured to receive a latch pin and a rotor. The latch receiving assembly may comprise a rotor for actuating the at least one latch receiving assembly. The at least one latch receiving assembly may be in selective communication with the first actuation mechanism and the second actuation mechanism such that the first actuation mechanism and the second actuation mechanism each comprise an unengaged position, an independent engaged position, and a dependent engaged position relative to the at least one latch receiving assembly. The first actuation mechanism and the second actuation mechanism may be placed in different combinations of unengaged, independent engaged, and dependent engaged positions to facilitate actuating the latching mechanism with both the first and second actuation mechanisms (both actuation mechanisms are unlocked), either the first or the second actuation mechanism (one actuation mechanism is locked, the other is unlocked), or neither of the first and second actuation mechanisms (both actuation mechanisms are locked). The storage container may be configured such that, when the storage container is in the closed position, the latching mechanism of the first portion releasably receives the at least one latch pin such that the first portion of the storage container is releasably secured to the second portion of the storage container.

### BRIEF DESCRIPTION OF THE DRAWINGS

The following description of the specific illustrative embodiments of the present invention can be understood when read in conjunction with the following drawings in which:

FIG. 1 is a side view of a latching mechanism in accordance with one embodiment of the present invention;

FIG. 2 is a perspective view of an actuation mechanism for use in conjunction with a latching mechanism in accordance with one embodiment of the present invention;

FIG. 3A is a top view of the first actuator rod for use in conjunction with a latching mechanism in accordance with one embodiment of the present invention;

FIG. 3B is a top view of the first actuator rod with a rod end adaptor for use in conjunction with a latching mechanism in accordance with one embodiment of the present invention;

FIG. 4A is a side view of the second actuator rod for use in conjunction with a latching mechanism in accordance with one embodiment of the present invention;

FIG. 4B is a top view of the second actuator rod for use in conjunction with a latching mechanism in accordance with one embodiment of the present invention;

FIG. 4C is a top view of the second actuator rod with a rod end adaptor for use in conjunction with a latching mechanism in accordance with one embodiment of the present invention;

FIG. 5 is a side view of a latching mechanism in accordance with one embodiment of the present invention;

FIGS. 6A-6D are partial top views of a latching mechanism in accordance with one embodiment of the present invention illustrating different modes of operation;

FIG. 7 is a side view of a latching mechanism in accordance with one embodiment of the present invention;

FIGS. 8A-8D are partial top views of a latching mechanism in accordance with one embodiment of the present invention illustrating different modes of operation;

FIG. 9 is a perspective view of a latching mechanism in accordance with one embodiment of the present invention installed in a vehicle storage container; and

FIG. 10 is a perspective view of a latching mechanism in accordance with one embodiment of the present invention installed in a vehicle storage container.

### DETAILED DESCRIPTION OF THE ILLUSTRATIVE EMBODIMENTS

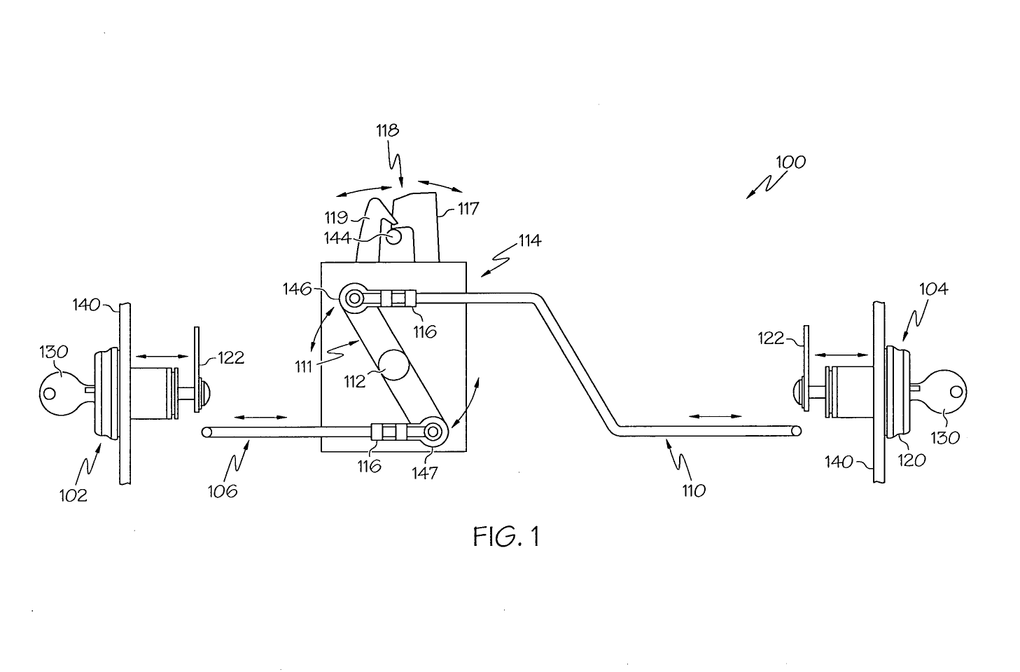

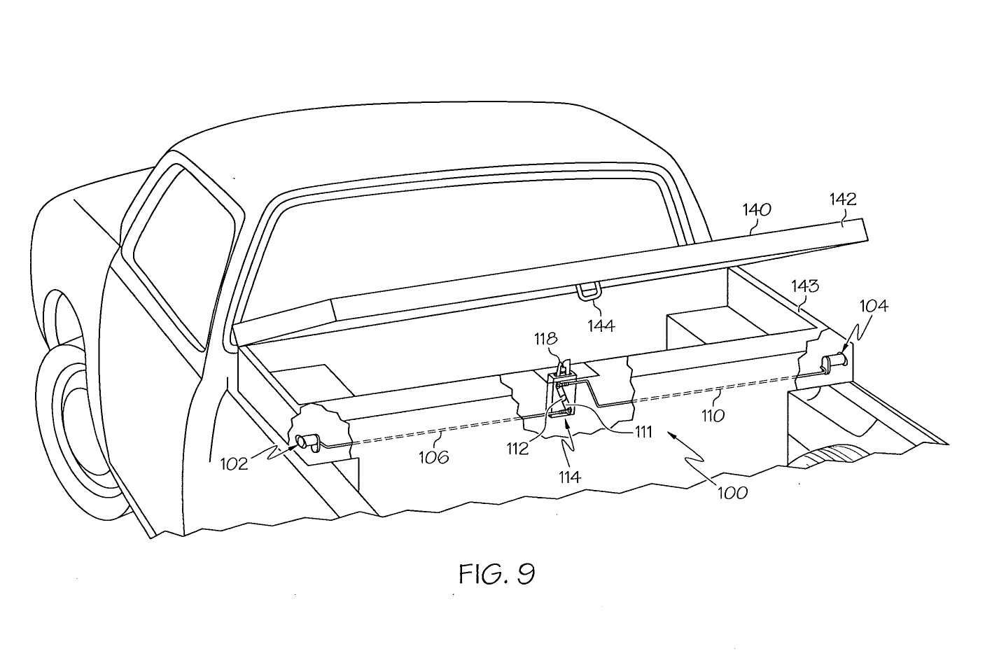

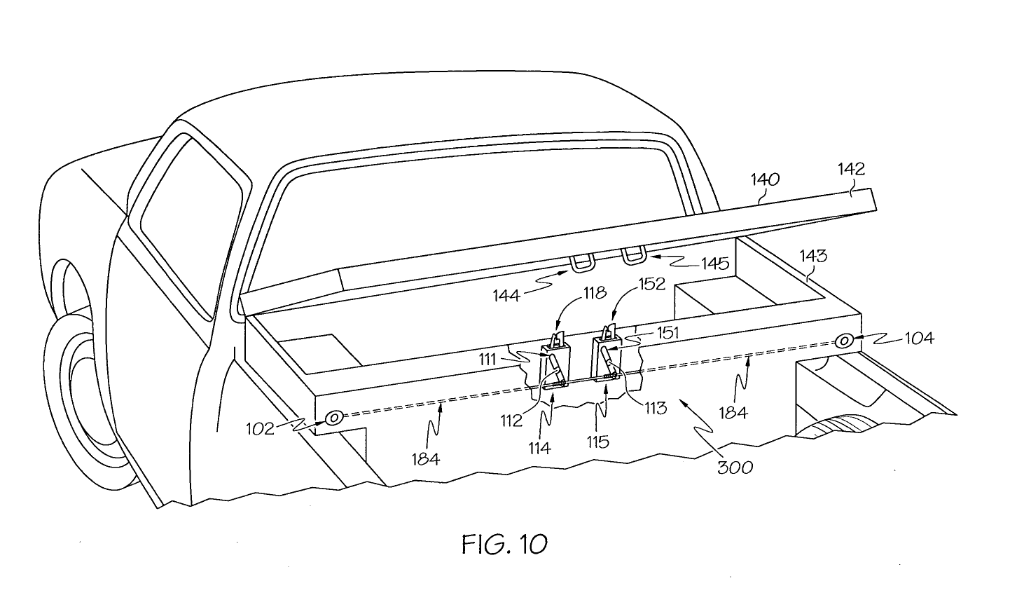

FIG. 1 shows a latching mechanism in accordance with one embodiment of the present invention for use with a storage container for a vehicle, as illustrated in FIGS. 9-10. As described herein, the latching mechanisms of the present invention facilitate dual push-button storage container latches with multiple independent and dependent latching modes. As generally illustrated in FIG. 1, the latching mechanism 100 may generally comprise a first actuation mechanism 102, a second actuation mechanism 104, and at least one latch receiving assembly 114. Each of these elements will be described more fully herein.

Referring to FIGS. 1-4C, a latching mechanism 100 in accordance with one embodiment of the present invention is shown. The latching mechanism 100 may comprise a first actuation mechanism 102 and a second actuation mechanism 104 oriented in opposition to one another. The actuation mechanisms 102, 104, illustrated in FIGS. 1-10 as a push-button actuation mechanism, may generally comprise a push button 120 positioned in a housing 136. The housing 136 may be attached to a body 134. A shaft 128 may be slidably disposed in the body 134 and operatively connected to the push button 120 such that, when the push button 120 is depressed a first time, the shaft 128 extends from the body 134; when the push button 120 is depressed a second time, the shaft 128 retracts into the body 134. The direction of travel of the shaft 128 is indicated by arrow 132. The travel of the push button 120, and therefore the extension of the shaft 128, is limited by a ledge 126 positioned inside the housing 136 of the actuation mechanism 102, 104.

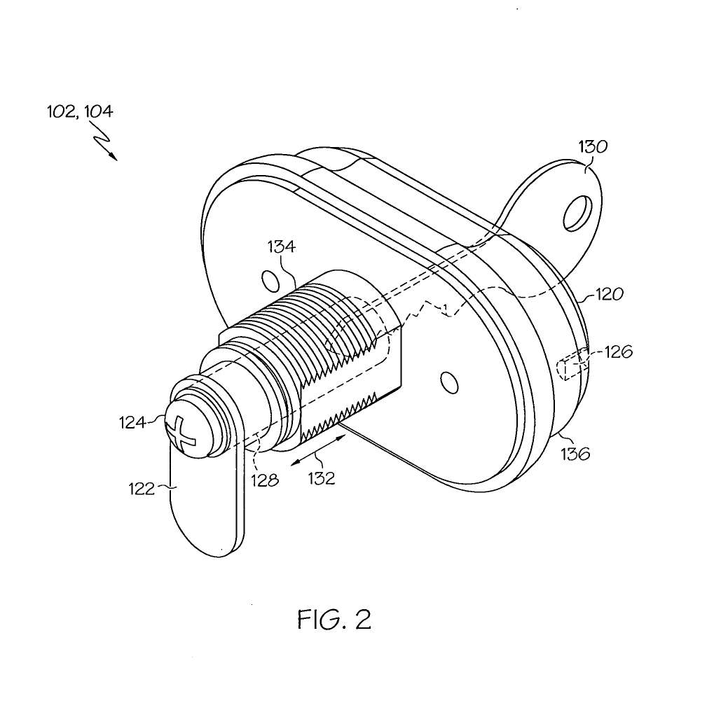

The push button 120 and operatively connected shaft 128 may be formed with a keyway (not shown) for receiving a key 130 (shown inserted in the keyway) as shown in FIG. 2. The keyway may extend through the push button 120 and into the body 134. When inserted in the keyway, the key 130 may facilitate the rotation of the push button 120 and shaft 128 relative to the body 134, which remains stationary.

A cam 122 may be adjustably attached to the end of the shaft 128 by a cam screw 124 threaded though the cam 122 and into the end of the shaft 128. The cam 122 may be oriented on the shaft 128 such that the cam 122 is perpendicular to the direction of travel of the shaft 128 and the cam 122 and shaft 128 have an L-shaped configuration. The attachment of the cam 122 to the shaft 128 may facilitate the rotation of the cam 122 by rotating the key 130 in the keyway. The cam 122 may be extended or retracted by actuating the push button 120 such that the shaft 128 to which the cam 122 is attached is extended or retracted. While a push button actuation mechanism is described and illustrated herein, it will be appreciated by one skilled in the art that the first actuation mechanism 102 and the second actuation mechanism 104 may be any suitable actuation mechanism for interfacing with a latch receiving assembly (discussed herein later), such as a paddle latch or other arrangement.

Still referring to the latching mechanism 100 shown in FIGS. 1-4B, at least one latch receiving assembly 114 may be disposed between the first actuation mechanism 102 and the second actuation mechanism 104 as shown in FIG. 1. The latch receiving assembly 114 comprises a latch 118 for receiving a latch pin 144. The latch 118 may include two opposable sides 117, 119 wherein the sides 117, 119 are configured to move away from one another upon receiving the latch pin 144 and further configured to move back toward each other and releasably engage the latch pin 144 upon completion of receipt. The latch receiving assembly 114 may also comprises a rotor 112 operatively attached to the latch 118. The rotor 112 may be actuated by a rotor lever 111 attached to the rotor 112. The rotor lever 111 may have an upper end 146 and a lower end 147. Actuating the rotor 112 opens the opposable sides 117, 119 of the latch 118 of the latch receiving assembly 114 thereby releasing the latch pin 144.

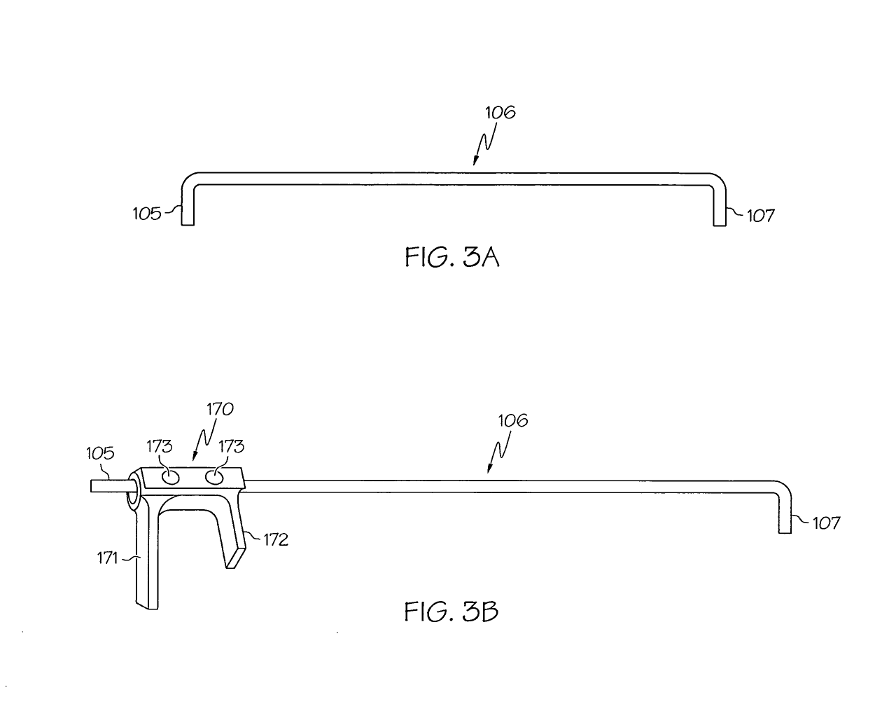

The latch receiving assembly 114 may be in mechanical communication with the first actuation mechanism 102 via the first actuation rod 106 extending between the latch receiving assembly 114 and the first actuation mechanism 102. The first actuation rod 106 may be circular in cross section with a first end 105 and a second end 107. The first end 105 and second end 107 of the first actuation rod 106 may have 90 degree jogs such that the first actuation rod 106 has a broad, shallow C-shaped configuration as shown in FIG. 3A. The second end 107 of the first actuation rod 106 may be pivotally connected to the lower end 147 of the rotor lever 111 and secured to the rotor lever 111 with a rod end clevis clip 116 or other suitable attachment. The first end 105 of the first actuation rod 106 may be positioned proximate the cam 122 of the first actuation mechanism 102 such that the cam 122 may be removably placed in mechanical contact with the first end 105 of the first actuation rod 106. The 90 degree jog on the first end 105 of the first actuation rod 106 increases the contact area between the cam 122 of the first actuation mechanism 102 and the first actuation rod 106.

Alternatively, instead of a 90 degree jog, the first end 105 of the first actuation rod 106 may be fitted with a rod end adapter 170 as shown in FIG. 3B. The rod end adapter 170 comprises tabs 171, 172 that extend perpendicularly from the rod end adapter 170. The rod end adapter 170 is slidably received on the first end 105 of the first actuation rod 106 and secured into place with set screws 173. The tabs 171, 172 may provide an interface between the cam 122 of the first actuation mechanism 102 and the first actuation rod 106. The tabs 171, 172 extend from the rod end adapter 170 in different directions and may provide adjustability in positioning the adapter 170 relative to the cam of the first actuation mechanism 102. It should be understood that, while FIG. 3B depicts a rod end adapter 170 having two tabs 171, 172, the rod end adapter 170 may have one tab or multiple tabs with each individual tab extending from the rod end adapter 170 in different directions.

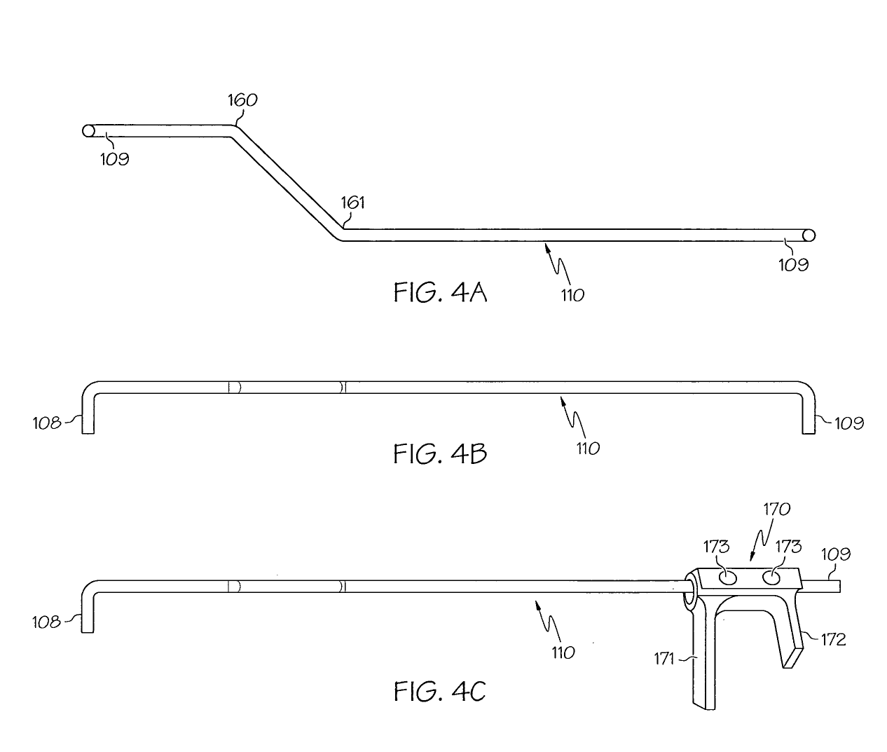

The latch receiving assembly 114 may be in mechanical communication with the second actuation mechanism 104 via a second actuation rod 110 extending between the latch receiving assembly 114 and the second actuation mechanism 102. The second actuation rod 110 may extend between the upper end 146 of the rotor lever 111 and the cam 122 of the second actuation mechanism 104. The second actuation rod 110 may be circular in cross section with a first end 108 and a second end 109. As shown in FIG. 4B, each of the first end 108 and second end 109 of the second actuation rod 110 may have 90 degree jogs. Alternatively, the second end 109 of the second actuation rod 110 may be fitted with a rod end adapter 170 as shown in 4C. As shown in FIG. 4A, to facilitate the extension of the second actuation rod 110 between the upper end 146 of the rotor lever 111 and the cam 122 of the second actuation mechanism 104, the second actuation rod 110 may contain two jogs 160, 161 between the first end 108 and second end 109 such that the second actuation rod 110 is offset. The first end 108 of the second actuation rod 110 may be pivotally connected to the upper end 146 of the rotor lever 111 and secured to the rotor lever 111 with a rod end clevis clip 116. The second end 109 of the second actuation rod 110 may be positioned proximate the cam 122 of the second actuation mechanism 104 such that the cam 122 may be removably placed in mechanical contact with the second end 109 of the second actuation rod 110.

It should be understood that, while FIGS. 1 and 4A-4C depict the second actuation rod 110 as having the first end 108 offset from the second end 109 to facilitate the connection between the cam 122 of the second actuation mechanism 104, the second actuation rod 110 may have the same configuration as the first actuation rod 106. When the second actuation rod 110 has the same configuration as the first actuation rod 106, the first actuation mechanism 102 and the second actuation mechanism 104 may be opposed to one another and offset such that the second actuation rod 110, the second actuation mechanism 104 and the upper end 146 of the rotor lever 111 are in alignment with each other.

Further, it should also be understood that, while FIG. 1 depicts the first actuation rod 106 and the second actuation rod 110 as being pivotally connected to the rotor lever 111 with rod end clevis clips 116, the first actuation rod 106 and the second actuation rod 110 may be pivotally connected to the first actuation rod 106 and the second actuation rod 110 with any connector suitable for pivotally attaching a rod to another component including, without limitation, pins and clips.

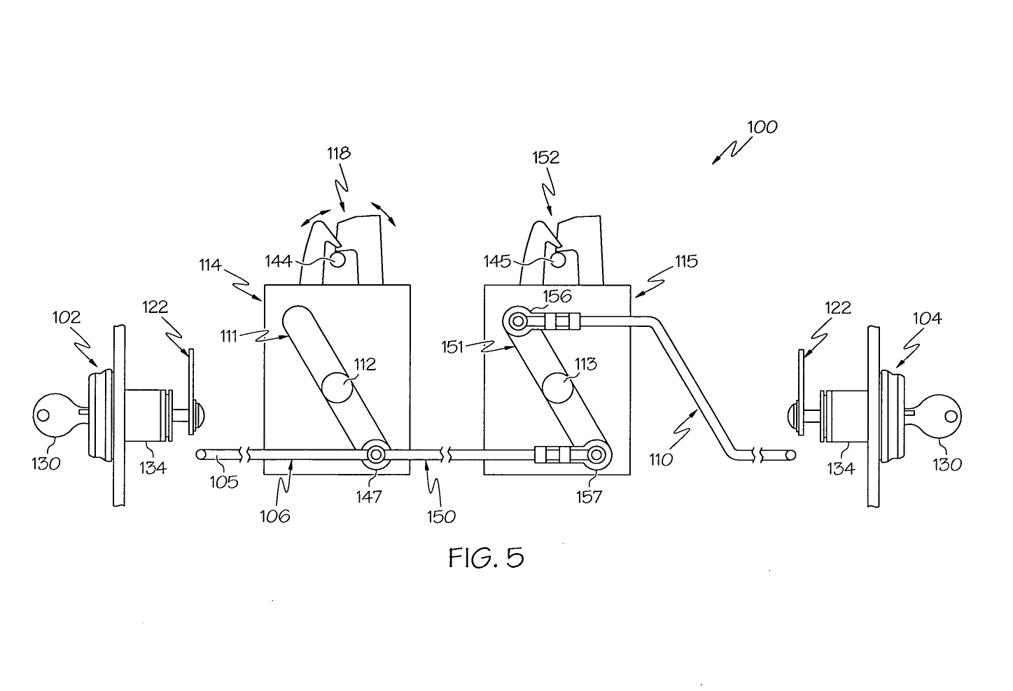

Referring now to FIG. 5, in another embodiment of the latching mechanism 200 of the present invention, the latching mechanism 200 may comprise a second latch receiving assembly 115 disposed between the first actuation mechanism 102 and the second actuation mechanism 104 and connected in series with the latch receiving assembly 114. The second latch receiving assembly 115 may comprise a second latch 152 for receiving a second latch pin 145. The second latch 152 may be operatively attached to a second rotor 113. The second rotor 113 may be actuated by rotating a second rotor lever 151. The second rotor lever 151 may have an upper end 156 and a lower end 157. Actuating the second rotor 113 opens or closes the second latch 152 of the second latch receiving assembly 115 thereby securing or releasing the second latch pin 145.

In the embodiment of the latching mechanism 200 shown in FIG. 5, the latch receiving assembly 114 and the first actuation mechanism 102 may be in mechanical communication with one another via the first actuation rod 106 disposed between the latch receiving assembly 114 and the first actuation mechanism 102 as discussed and illustrated herein with respect to the embodiment of the latching mechanism 100 shown in FIG. 1.

The latch receiving assembly 114 and second latch receiving assembly 115 may be in mechanical communication with each other via a linking actuation rod 150. The linking actuation rod 150 may be disposed between the latch receiving assembly 114 and the second latch receiving assembly 115. The linking actuation rod 150 may have the same configuration as the first actuation rod 106 shown in FIG. 3A with a first end 153 and a second end 154, the first end 153 and second end 154 having 90 degree jogs. The first end 153 of the linking actuation rod 150 may be pivotally connected with the lower end 147 of the rotor lever 111 and secured with a rod end clevis clip 116. The second end 154 of the linking actuation rod 150 may be pivotally attached to the lower end 147 of the second rotor lever 151 and secured with a rod end clevis clip 116.

The second latch receiving assembly 115 may be in mechanical communication with the second actuation mechanism 104 via the second actuation rod 110 in a similar manner as the first actuation mechanism 102 and the second actuation rod 110 as previously discussed herein and illustrated in FIG. 1.

Based on the exemplary embodiments of the latching mechanism 100, 200 shown in FIGS. 1 and 5, respectively, it should be understood that additional latch receiving assemblies may be added to the latching mechanism 100 and connected in series with additional actuation rods in a configuration similar to that shown in FIG. 5.

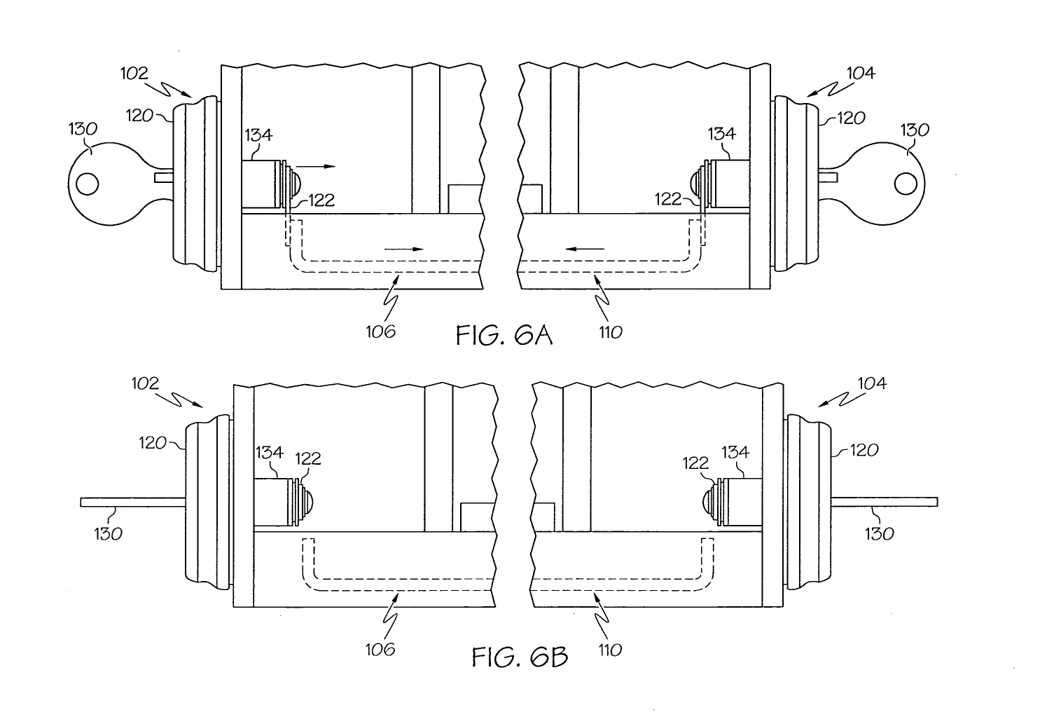

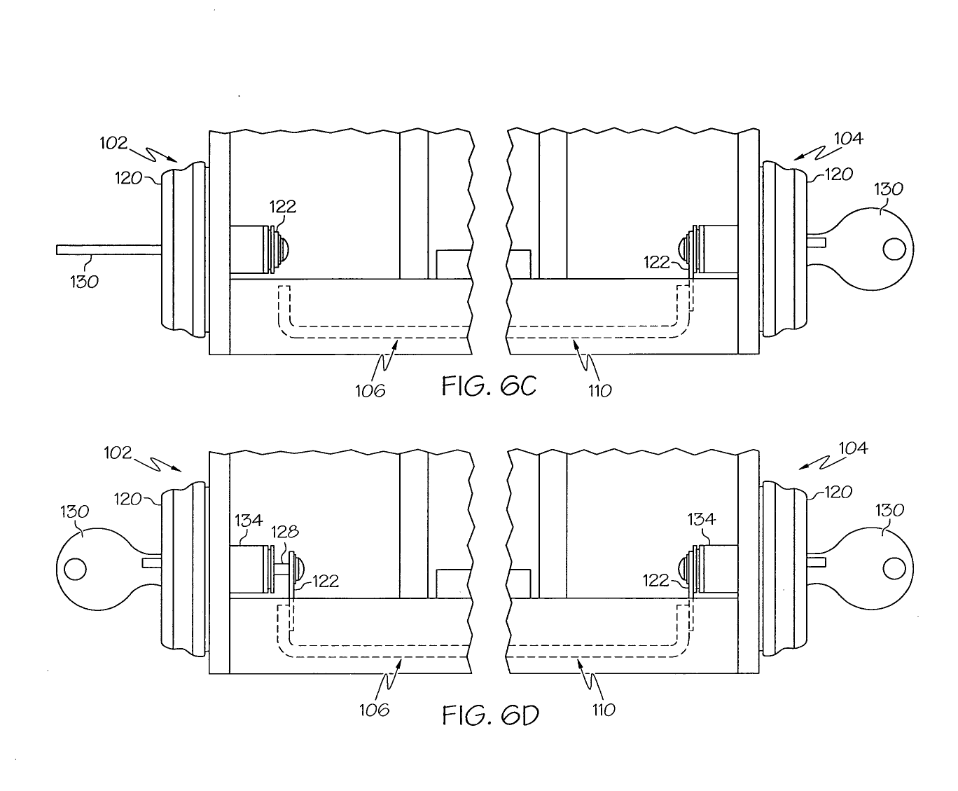

Referring now to FIGS. 1, 5 and 6A-6D, several different independent and dependent modes of operation are depicted for the embodiments of the latching mechanism 100, 200 shown in FIGS. 1 and 5, respectively. Each mode of operation illustrated in FIGS. 6A-6D is dependent on the position (vertical or horizontal) of the cams 122 of the first and second actuation mechanisms 102, 104 and the position (in or out) of each push button 120 of the first and second actuation mechanisms 102, 104. The modes of operation of the latching mechanism 100, 200 shown in FIGS. 6A-6D are a partial top view of the latching mechanism 100, 200 depicting the position of the cam 122 of the first actuation mechanism 102 relative to the first actuation rod 106 and the position of the cam 122 of the second actuation mechanism 104 relative to the second actuation rod 110.

It should be understood that the position of the cam 122 of each of the actuation mechanisms 102, 104 may be adjusted by rotating the key 130 in the key way (not shown), actuating the push button 120, or both. For either of the actuation mechanisms 102, 104, when the push button is “in,” the shaft 128 is extended from the body 134 such that the attached cam 122 is extended outwards, in a position furthest from the body 134. When the push button is “out,” the shaft 128 is retracted into the body 134 such that the attached cam 122 is positioned closest to the body 134. Pressing and releasing the push button 120 switches the actuation mechanism 102, 104 between “in” and “out” modes. Further, it should also be noted that, for either actuation mechanism 102, 104, the cams 122 of each actuation mechanism 102, 104 may be rotated from a vertical position to a horizontal position or from a horizontal position to a vertical position by rotating the key 130 in each respective actuation mechanism 102, 104.

Referring now to FIGS. 1 and 6A to illustrate the basic operation of the latching mechanism 100, the cam 122 and shaft 128 of each actuation mechanism 102 and 104 may be positioned by operation of the push button 120 such that each respective shaft 128 is retracted into the body 134 of each actuation mechanism 102, 104. The cams 122 of each actuation mechanism 102, 104 are positioned by rotating the key 130 such that each cam 122 is in mechanical contact with either the first actuation rod 106 or second actuation rods 110, respectively, as shown in FIG. 6A. In this configuration the first actuation mechanism 102 and second actuation mechanism 104 are each independently engaged with the first actuation rod 106 and second actuation rod 110. When the push button 120 of first actuation mechanism 102 is depressed, the shaft 128 of the first actuation mechanism 102 extends from the body 134 and forces the cam 122 against the first actuation rod 106 which moves towards the latch receiving assembly 114. The motion of the first actuation rod 106 towards the latch receiving assembly 114 causes the rotor lever 111 to rotate. The motion of the rotor lever 111 is communicated to the rotor 112 which actuates the latch 118 opening opposable sides 117, 119 of the latch 118 thereby releasing the latch pin 144. In addition to actuating the latch receiving assembly 114, the rotor 112 also functions to reverse the direction of travel communicated from the first actuation rod 106 to the second actuation rod 110 and vice versa. For example, in the mode of operation shown in FIG. 6A, the first actuation rod 106 is pushed towards the latch receiving assembly 114 when the first actuation mechanism 102 is depressed. This motion of the actuation rod 106 causes the rotor 112 and rotor lever 111 to rotate which, in turn, pulls the attached second actuation rod 110 towards the latch receiving assembly 114.

Alternatively, the push button 120 of the second actuation mechanism 104 may be depressed causing the shaft 128 to extend from the body 134 of the second actuation mechanism 104 and forcing the cam 122 against the second actuation rod 110. This pushes the second actuation rod 110 towards the latch receiving assembly 114 causing the rotor lever 111 to rotate. The rotation of the rotor lever 111 is communicated to the rotor 112 which actuates the latch 118 and opens opposable sides 117, 119 of the latch 118 thereby releasing the latch pin 144. Due to the motion of the rotor lever 111, the push on the second actuation rod 110 is communicated to the first actuation rod 106 as a pull and the first actuation rod 106 is pulled away from the cam 122 of the first actuation mechanism 102 and towards the latch receiving assembly 114.

Referring now to the exemplary embodiment of the latching mechanism 200 shown in FIG. 5, when the cams 122 of the first and second push button mechanisms 102, 104 are positioned as shown in FIG. 6A, the embodiment of the latching mechanism 200 shown in FIG. 5 has a similar functionality as the embodiment of the latching mechanism shown in FIG. 1. By way of example, when the push button 120 of the first actuation mechanism 102 is depressed, the shaft 128 of the first actuation mechanism 102 extends from the body 134 and forces the cam 122 against the first actuation rod 106 which moves towards the latch receiving assembly 114. The motion of the first actuation rod 106 causes the rotor lever 111 to rotate. The rotation of the rotor lever 111 is communicated to the rotor 112 which actuates the latch 118 and opens opposable sides 117, 119 of the latch 118 thereby releasing the latch pin 144. The rotation of the rotor lever 111 also causes the linking actuation rod 150 to move towards the second latch receiving assembly 115. The motion of the linking actuation rod 150 causes the rotation of the second rotor lever 151 which is communicated to the second rotor 113. The rotation of the second rotor 113 actuates the second latch 151 thereby releasing the second latch pin 145. Due to the action of the rotor lever 111, a push on the first actuation rod 106 communicated to the linking actuation rod 150 is translated to the second actuation rod 110 as a pull and the second actuation rod 110 is pulled away from the cam 122 of the second actuation mechanism 104 and towards the second latch receiving assembly 115.

It should now be understood that the exemplary embodiments of the latching mechanism 100, 200 shown in FIGS. 1 and 5, respectively, have similar functionality irrespective of the number of latch receiving assemblies incorporated into the latching mechanism 100. Accordingly, the remainder of the discussion concerning modes of operation of the latching mechanism 100, 200 will refer to FIGS. 6B-6D read in conjunction with the exemplary embodiment of the latching mechanism 100 shown in FIG. 1 which incorporates a single latch receiving assembly 114.

FIG. 6B illustrates a mode of operation of the latching mechanism 100 in which the first actuation mechanism 102 and the second actuation mechanism 104 are independently locked. In this mode, the cam 122 of the first actuation mechanism 102 is positioned vertically such that it is out of contact with the first actuation rod 106. The cam 122 of the second actuation mechanism 104 is also positioned vertically and out of contact with the second actuation rod 110. In this configuration the first actuation mechanism 102 and the second actuation mechanism are disengaged from the actuation rod 106 and second actuation rod 110. The push button 120 of either actuation mechanism 102, 104 may be positioned either “in” or “out” without effecting the functionality of the latching mechanism 100 for the particular mode of operation shown in FIG. 6B. In this configuration, the latch receiving assembly 114 cannot be actuated by either of the actuation mechanisms 102, 104 because the first actuation rod 106 and second actuation rod 110 are not in contact with either of the cams 122 of the respective actuation mechanisms 102, 104. Accordingly, in this configuration, both the first actuation mechanism 102 and the second actuation mechanism 104 are independently locked.

FIG. 6C illustrates a mode of operation of the latching mechanism 100 in which the first actuation mechanism 102 is independently locked and the second actuation mechanism 104 is independently unlocked. In this mode of operation the cam 122 of the first actuation mechanism 102 is in a vertical position and not in mechanical contact with the first actuation rod 106. The push button 120 of the first actuation mechanism 102 is in the “out” position such that the shaft 128 of the first actuation mechanism 102 is retracted in the body 134 of the first actuation mechanism 102. The cam 122 of the second actuation mechanism 104 is in a horizontal position and in contact with the second actuation rod 110. The push button 120 of the second actuation mechanism 104 is in the “out” position such that the shaft 128 of the second actuation mechanism 104 is retracted in the body 134 of the second actuation mechanism 104. In this configuration the first actuation mechanism 102 is disengaged from the actuation rod 106 while the second actuation mechanism 104 is independently engaged with the second actuation rod 110.

In the mode shown in FIG. 6C, the first actuation mechanism 102 is independently locked as depressing the push button 120 of the first actuation mechanism 102 will not actuate the latch receiving assembly 114. However, the second actuation mechanism 104 is independently unlocked as depressing the push button 120 of the second actuation mechanism 104 will force the cam 122 of the second actuation mechanism 104 into the second actuation rod 110 thereby sliding the second actuation rod 110 towards and actuating the latch receiving assembly 114 releasing the latch pin 144. It should be understood that, while FIG. 6C depicts the first actuation mechanism 102 as independently locked and the second actuation mechanism 104 as independently unlocked, the first actuation mechanism 102 may be independently unlocked (independently engaged) by orienting the cam 122 of the first actuation mechanism 102 horizontally and the second actuation mechanism 104 may be independently locked (and disengaged) by orienting the cam 122 of the second actuation mechanism 104 vertically.

FIG. 6D illustrates another mode of operation of the latching mechanism 100 in which both the first actuation mechanism 102 and the second actuation mechanism 104 are dependently locked. In this configuration the push button 120 of the first actuation mechanism 102 is in the “in” position such that the shaft 128 of the first actuation mechanism 102 is extended. The shaft 128 and attached cam 122 of the first actuation mechanism 102 are then rotated such that the cam 122 of the first actuation mechanism 102 is positioned behind the 90 degree jog of the first actuation rod 106. The push button 120 of the second actuation mechanism 104 is in the “out” position such that the shaft 128 of the second actuation mechanism 104 is retracted into the body 134. The cam 122 of the second actuation mechanism 104 is positioned horizontally such that the cam 122 is in mechanical contact with the second actuation rod 110. In this configuration the first actuation mechanism 102 is dependently engaged with the actuation rod 106 while the second actuation mechanism is independently engaged with second actuation rod 110.

When the push button 120 of the first actuation mechanism 102 is depressed the cam 122 and the shaft 128 of the first actuation mechanism 102 will not move. This is because the shaft 128 of the first actuation mechanism 102 is already fully extended and cannot retract into the body of the first actuation mechanism 102 because of the position of the attached cam 122 relative to the first actuation rod 106. Accordingly, the first actuation mechanism 102 is locked.

When the push button 120 of the second actuation mechanism 104 is depressed the cam 122 of the second actuation mechanism 104 pushes against the second actuation rod 110. However, the second actuation rod 110 cannot move towards the latch receiving assembly 114. This is because of the position of the cam 122 of the first actuation mechanism 104 in relation to the first actuation rod 106. When both the second actuation rod 110 and the first actuation rod 106 are free to move towards and away from the latch receiving assembly 114, a push on the second actuation rod 110 is translated to a pull on the first actuation rod 106 by action of the rotor 112. However, with the cam 122 of the first actuation mechanism 102 positioned as illustrated in FIG. 6D, the first actuation rod 106 cannot be pulled towards the latch receiving assembly 114 by the rotation of the rotor 112 and rotor lever 111. Accordingly, the rotor lever 111 and rotor 112 are not free to rotate which, in turn, inhibits the motion of the second actuation rod 110 in the direction of the latch receiving assembly 114. In this configuration the operation of both first and second actuation mechanisms 102, 104 are dependent on the position of the cam 122 of the first actuation mechanism 102. As such, the first and second actuation mechanism 102, 104 are dependently locked. It should be understood that the first actuation mechanism 102 and the second actuation mechanism 104 may be configured such that both the first and second actuation mechanism 102, 104 are dependently locked based on the position of the cam 122 of the right position mechanism 104.

Still referring to the modes of operation illustrated in FIGS. 6A-6D, it should now be understood that the cam 122 of each actuation mechanism 102, 104 may be positioned such that the actuation mechanism 102, 104 is disengaged from the respective actuation rods 106, 110, independently engaged with the actuation rods 106, 110, or dependently engaged with the actuation rods 106, 110. The type of engagement may determine whether the actuation mechanisms 102, 104 are independently locked, independently unlocked, or dependently locked.

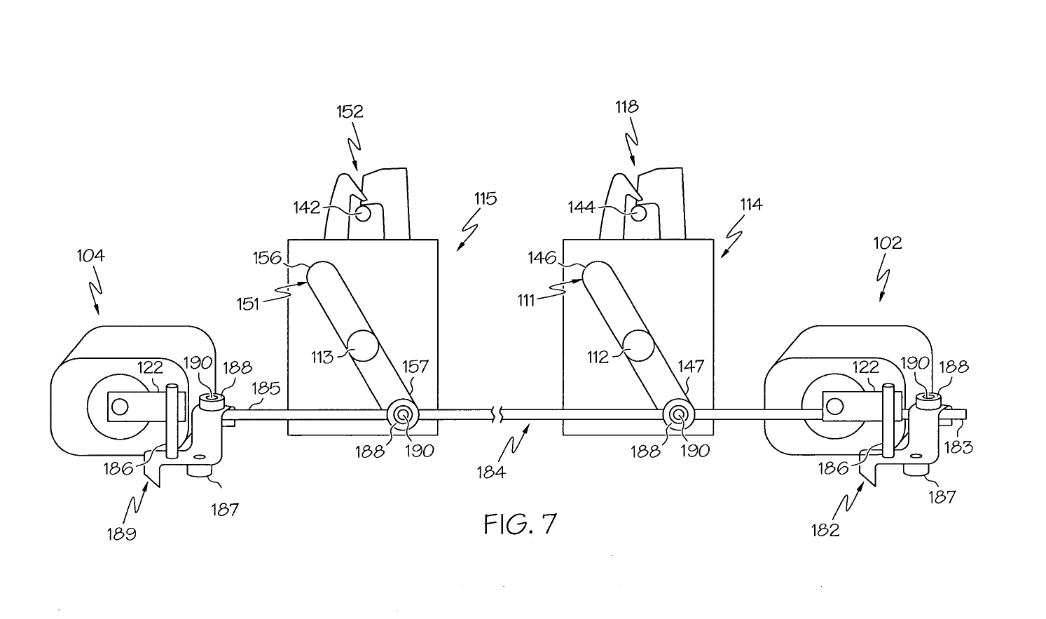

Referring now to FIG. 7, another exemplary embodiment of the latching mechanism 300 in accordance with the present invention is shown. In this embodiment, the latching mechanism 300 may comprise a first actuation mechanism 102 and a second actuation mechanism 104 oriented in parallel to each other. The latching mechanism 300 may also comprises a first latch receiving assembly 114 and a second latch receiving assembly 115 disposed between the first actuation mechanism 102 and the second actuation mechanism 104. An actuation rod 184 having a first end 183 and a second end 185 extends between the first actuation mechanism 102 and the second actuation mechanism 104. The rod 184 is pivotally connected to the bottom end 147 of the rotor lever 111 of the first latch receiving assembly 114 via connector 188 and set screw 190. The rod 184 is also pivotally connected to the bottom end 157 of the rotor lever 151 of the second latch receiving assembly 115. While FIG. 7 depicts the rod 184 as being pivotally connected to the bottom ends 147, 157 of rotor levers 111 and 151, respectively, it should be understood that the rod 184 may be connected to the top ends 146, 156 of rotor levers 111, 151, respectively. It should also be understood that, while the embodiment of the latching mechanism 300 shown in FIG. 7 is depicted with two latch receiving assemblies 114, 115, the latching mechanism 300 may comprise one latch receiving assembly or multiple latch receiving assemblies configured in a similar manner with the same functionality.

The first end 183 and second end 185 of the rod 184 may be connected to actuation levers 182, 189, respectively via connectors 188 and set screws 190, as shown in FIG. 7. Each actuation lever 182, 189 comprises a post 186 and a pivot 187. The actuation lever 182 pivotally connected to the first end 183 of the rod 184 may be positioned such that the cam 122 of the first actuation mechanism 102 may be in mechanical contact with the post 186 of the actuation lever 182. The actuation lever 182 connected to the second end 185 of the rod 184 may be positioned such that the cam 122 of the second actuation mechanism 104 may be in mechanical contact with the post 186 of the actuation lever 182.

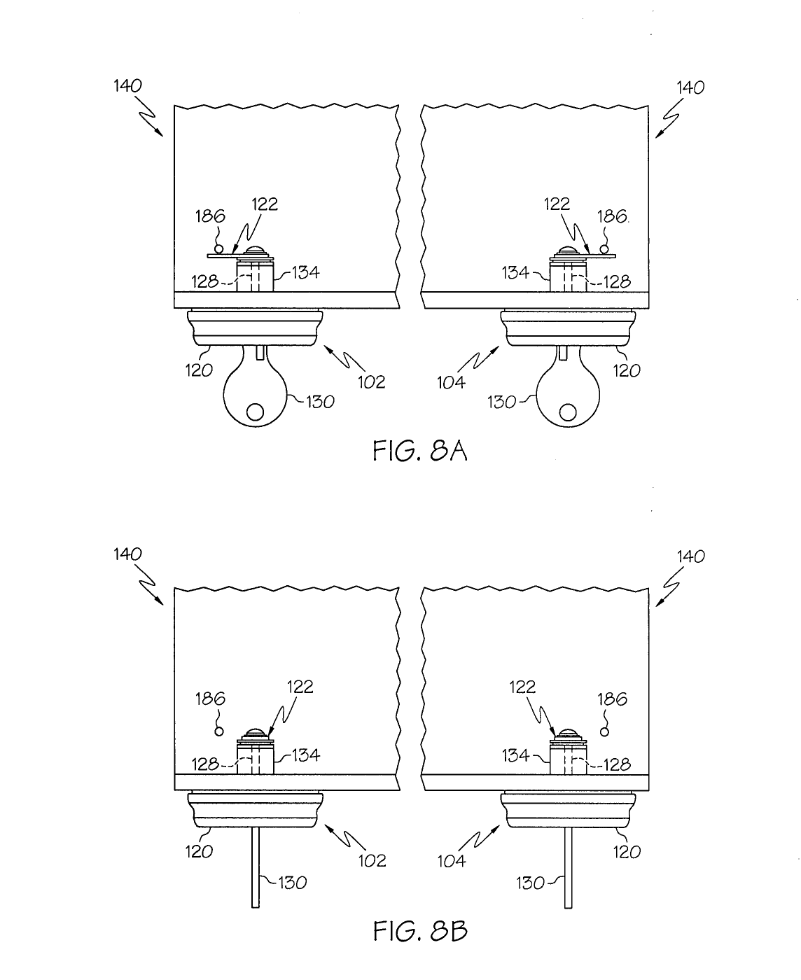

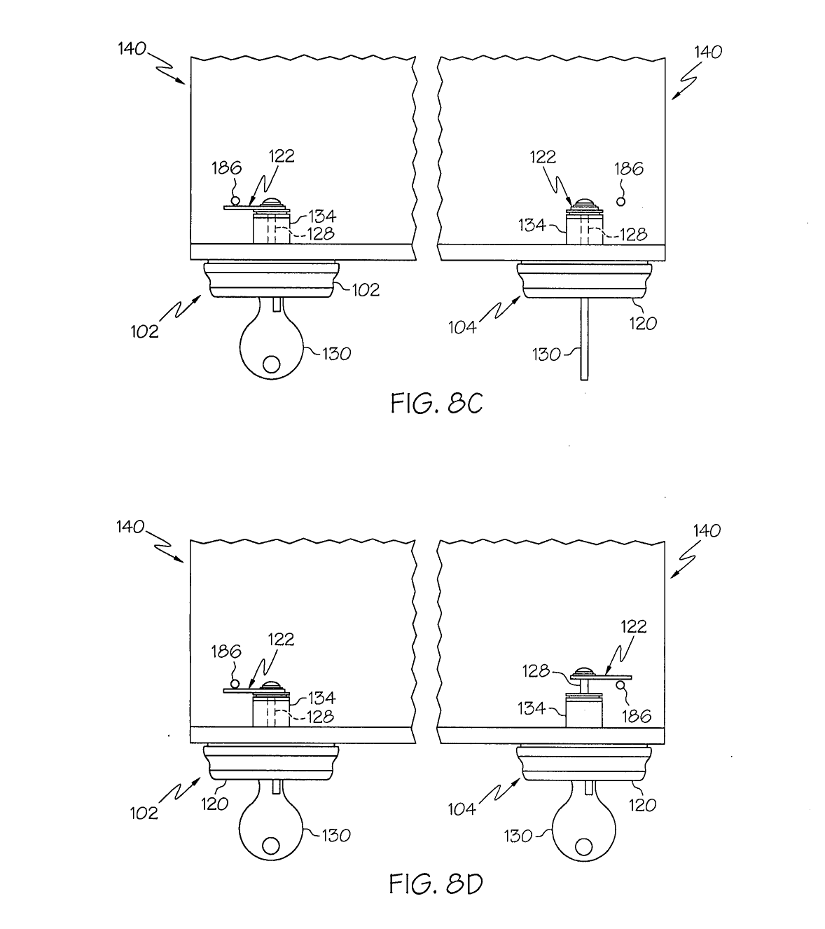

Referring now to FIGS. 7 and 8A-8B, the basic modes of operation of the embodiment of the latching mechanism 300 shown in FIG. 7 are illustrated. Each mode of operation illustrated in FIGS. 8A-8D is dependent on the position (vertical or horizontal) of the cams 122 of the first and second actuation mechanisms 102, 104 and the position (in or out) of each push button 120 of the first and second actuation mechanisms 102, 104. Accordingly, FIGS. 8A-8D are a partial top view of the latching mechanism 300 depicting the position of the cams 122 of the first actuation mechanism 102 and the second actuation mechanism 104 relative to the posts 186 of the left actuation lever 182 and the right actuation lever 189.

As discussed herein with respect to FIGS. 6A-6D, for either of the actuation mechanisms 102, 104, when the push button is “in,” the shaft 128 is extended from the body 134 such that the attached cam 122 is extended outwards, in a position furthest from the body 134. When the push button is “out,” the shaft 128 is retracted into the body 134 such that the attached cam 122 is positioned closest to the body 134. Pressing and releasing the push button 120 switches the actuation mechanism 102, 104 between “in” and “out” modes. Further, it should also be noted that, for either actuation mechanism 102, 104, the cams 122 of each actuation mechanism 102, 104 may be rotated from a vertical position to a horizontal position or from a horizontal position to a vertical position by turning the key 130 in each respective actuation mechanism 102, 104.

FIG. 8A depicts a mode of operation in which the actuation mechanisms 102, 104 may be locked and unlocked independently. As shown in FIG. 8A, the cams 122 of each actuation mechanism 102, 104 may be positioned by operation of each push button (not shown) and key (not shown) so that the cam 122 is positioned horizontally and each cam 122 is in mechanical contact with the post 186 of the respective actuation levers 182, 189 and positioned between the post 186 and the actuation mechanism 102. In this configuration the first actuation mechanism 102 and the second actuation mechanism 104 are each independently engaged with actuation levers 182,189, respectively. When the first actuation mechanism 102 is actuated by depressing the push button 120, the cam 122 is extended against the post 186 of the actuation lever 182 connected to the first end 183 of the rod 184. This causes the actuation lever 182 to rotate about the pivot 187 causing the attached rod 184 to move towards the first latch receiving assembly 114. Because the rod 184 is pivotally connected to both the rotor lever 111 of the first latch receiving assembly 114 and the rotor lever 151 of the second latch receiving assembly 115, the motion of the rod 184 causes the rotation of both rotor levers 111, 151 thereby actuating the latches 118, 152 of both the first latch receiving assembly 114 and second latch receiving assembly 115 and releasing the latch pins 144, 145. The lateral motion of the rod 184 from the first actuation mechanism 102 towards the first latch receiving assembly 114 also causes the actuation lever 182 pivotally connected to the second end 185 of the rod 184 to rotate about the pivot 187 thereby moving the pin 186 away from the cam 122 of the right side actuation mechanism 104.

Alternatively, when the push button (not shown) of the second actuation mechanism 104 is depressed, the cam 122 of the second actuation mechanism 104 extends against the post 186 of the actuation lever 182 connected to the second end 183 of the rod 184. This causes the actuation lever 182 to rotate about the pivot 187 pulling the rod 184 away from the second latch receiving assembly 115. Because the rod 184 is pivotally connected to both the rotor lever 151 of the second latch receiving assembly 115 and the rotor lever 111 of the first latch receiving assembly 114, the motion of the rod 184 causes the rotation of both rotor levers 111, 151 thereby actuating the latches 118, 152 of both the first latch receiving assembly 114 and second latch receiving assembly 115 and releasing the latch pins 144, 145. The lateral motion of the rod 184 towards the second actuation mechanism 104 also causes the actuation lever 182 pivotally connected to the first end 183 of the rod 184 to rotate about the pivot 187 thereby moving the pin 186 away from the cam 122 of the first actuation mechanism 102.

FIG. 8B illustrates a mode of operation of the latching mechanism 300 in which the first actuation mechanism 102 and the second actuation mechanism 104 are independently locked. In this mode, the cam 122 of the first actuation mechanism 102 is positioned vertically such that it is out of contact with the post 186 of the actuation lever 182. The cam 122 of the second actuation mechanism 104 is also positioned vertically and out of contact with the post 186 of the actuation lever 189. In this configuration both the first actuation mechanism 102 and the second actuation mechanism 104 are disengaged from the respective actuation levers 182, 189. The push button 120 of either actuation mechanism 102, 104 may be positioned either “in” or “out” without effecting the functionality of latching mechanism 300 for the particular mode of operation shown in FIG. 8B. In this configuration, the latch receiving assembly 114 cannot be actuated by either of the actuation mechanisms 102, 104 because the posts 186 are not in contact with either of the cams 122 of the respective actuation mechanisms 102, 104. Accordingly, in this configuration, both the first actuation mechanism 102 and the second actuation mechanism 104 are independently locked.

FIG. 8C illustrates a mode of operation of the latching mechanism 300 in which the first actuation mechanism 102 is independently unlocked and the second actuation mechanism 104 is independently locked. In this mode of operation the cam 122 of the first actuation mechanism 102 is in a horizontal position and in mechanical contact with the post 186 of the actuation lever 182. The push button 120 of the first actuation mechanism 102 is in the “out” position such that the shaft 128 of the first actuation mechanism 102 is retracted in the body 134 of the first actuation mechanism 102. The cam 122 of the second actuation mechanism 104 is in a vertical position and not in contact with the post 186 of the actuation lever 189. The push button 120 of the second actuation mechanism 104 is in the “out” position such that the shaft 128 of the second actuation mechanism 104 is retracted in the body 134 of the second actuation mechanism 104. With the cams 122 of the respective actuation mechanisms 102, 104 in this configuration, the first actuation mechanism 102 is independently engaged with the actuation lever 182 while the second actuation mechanism 104 is disengaged from the actuation lever 189.

In the mode shown in FIG. 8C, the second actuation mechanism 104 is independently locked as depressing the push button 120 of the second actuation mechanism 104 will not actuate the latch receiving assembly 114. However, the first actuation mechanism 102 is independently unlocked as depressing the push button 120 of the first actuation mechanism 102 will force the cam 122 of the first actuation mechanism 102 into the post 186 of the actuation lever 182 thereby sliding the actuation rod 184 towards and actuating the latch receiving assemblies 114, 115 allowing the latch pins 144, 145 to be released. It should be understood that, while FIG. 8C depicts the first actuation mechanism 102 as independently unlocked and the second actuation mechanism 104 as independently locked, the first actuation mechanism 102 may be independently locked by orienting the cam 122 of the first actuation mechanism 102 vertically and the second actuation mechanism 104 may be independently unlocked by orienting the cam 122 of the second actuation mechanism 104 horizontally.

FIG. 8D illustrates another mode of operation of the latching mechanism 300 in which both the first actuation mechanism 102 and the second actuation mechanism 104 are dependently locked. In this configuration the push button 120 of the second actuation mechanism 104 is in the “in” position such that the shaft 128 of the second actuation mechanism 102 is extended. The shaft 128 and attached cam 122 of the second actuation mechanism 104 are then rotated using the key 130 such that the cam 122 of the second actuation mechanism 104 is positioned behind the post 186 of the actuation lever 182 located on the right. The push button 120 of the first actuation mechanism 102 is in the “out” position such that the shaft 128 of the first actuation mechanism 102 is retracted into the body 134. The cam 122 of the first actuation mechanism 102 is positioned horizontally such that the cam 122 is in mechanical contact with the post 186 of the actuation lever 189. In this configuration the first actuation mechanism 102 is dependently engaged with the actuation lever 182 while the second actuation mechanism 104 is independently engaged with the actuation lever 189.

When the push button 120 of the second actuation mechanism 104 is depressed the cam 122 and post 186 proximate the second actuation mechanism 104 will not move. This is because the shaft 128 of the second actuation mechanism 104 is already fully extended and cannot retract into the body 134 of the second actuation mechanism 104 because of the position of the attached cam 122 relative to the post 186 of the actuation lever 189. Accordingly, the second actuation mechanism 104 is locked.

When the push button 120 of the first actuation mechanism 102 is depressed the cam 122 of the first actuation mechanism 102 pushes against the post 186 of the actuation lever 182. However, the position of the cam 122 of the second actuation mechanism 104 prevents the actuation lever 189 from rotating about the pivot 187. This, in turn, prevents the actuation rod 184 from moving laterally. If the actuation rod 184 cannot move laterally when either actuation mechanism 102, 104 is depressed, both actuation mechanisms 102, 104 are locked as neither can actuate the latch receiving assembly 114, 115. In this configuration both the actuation mechanisms 102, 104 are dependently locked based on the position of the cam 122 of the second actuation mechanism 104. It should be understood that the first actuation mechanism 102 and the second actuation mechanism 104 may be configured such that both the first and second actuation mechanisms 102, 104 are dependently locked based on the position of the cam 122 of the first actuation mechanism 102.

Still referring to the modes of operation illustrated in FIGS. 8A-8D, it should now be understood that the cam 122 of each actuation mechanism 102, 104 may be positioned such that the actuation mechanism 102, 104 is disengaged from the respective actuation lever 182, 189, independently engaged with the actuation levers 182, 189, or dependently engaged with the actuation levers 182, 189. The type of engagement may determine whether the actuation mechanisms 102, 104 are independently locked, independently unlocked, or dependently locked.

While FIGS. 6A-6D and FIGS. 8A-8D indicate basic modes of operability of the latching mechanisms 100, 200, 300 of the present invention, Table 1 shows the various modes of operability of the latching mechanisms 100, 200, 300 based on the position (either in or out) of the push buttons 120 of the first and second actuation mechanism 102, 104 and the position (either vertical or horizontal) of the cams 122 of the first and second actuation mechanisms 102, 104. Table 1 also indicates whether the actuation mechanisms 102, 104 are independently engaged, dependently engaged, or disengaged based on the position of the cams 122 and the push buttons 120 of the respective actuation mechanisms. Table 1 also indicates whether the first actuation mechanism 102 and the second actuation mechanism 104 are locked or unlocked based on the selected configuration and whether the first actuation mechanism 102 and the second actuation mechanism 104 operate in an independent mode or a dependent mode based on the selected configuration.

Still referring to Table 1, it should be noted that when the cams 122 of the first actuation mechanism 102 and the second actuation mechanism 104 have a vertical orientation such that they are disengaged, the push button 120 may be positioned either “in” or “out” without effecting the functionality of the configuration. When an actuation mechanism 102, 104 is disengaged, that actuation mechanism 102, 104 is locked and cannot facilitate actuation of the latching mechanism so as to release the latch pin.

It should also be noted that when an actuation mechanism 102, 104 is in the “in” position and the respective cam 122 is horizontal, that actuation mechanism 102, 104 is dependently engaged. When either actuation mechanism 102, 104 is dependently engaged, both actuation mechanisms 102, 104 are dependently locked irrespective of the configuration of the other actuation mechanism 102, 104. Accordingly, when either actuation mechanism 102, 104 is dependently engaged, both actuation mechanism 102, 104 are locked and neither can facilitate actuation of the latching mechanism so as to release the latch pin.

TABLE 1

| First Actuation Mechanism | | | Second Actuation Mechanism | | | | |
|---|---|---|---|---|---|---|---|
| | Cam of | | | Cam of | | | |
| | First | | Second | Second | | Latching Mechanism | |
| First Push | Actuation | Type of | Push | Actuation | Type of | | Mode of |
| Button | Mechanism | Engagement | Button | Mechanism | Engagement | Result | Operation |
| Out | Horizontal | Independently | Out | Horizontal | Independently | First and | Independent |
| | | Engaged | | | Engaged | Second | |
| | | | | | | Actuation | |
| | | | | | | Mechanisms | |
| | | | | | | Unlocked | |
| In/Out | Vertical | Disengaged | Out | Horizontal | Independently | First | Independent |
| | | | | | Engaged | Actuation | |
| | | | | | | Mechanism | |
| | | | | | | Locked; | |
| | | | | | | Second | |
| | | | | | | Actuation | |
| | | | | | | Mechanism | |
| | | | | | | Unlocked | |
| Out | Horizontal | Independently | In/Out | Vertical | Disengaged | First | Independent |
| | | Engaged | | | | Actuation | |
| | | | | | | Mechanism | |
| | | | | | | Unlocked; | |
| | | | | | | Second | |
| | | | | | | Locked | |
| In/Out | Vertical | Disengaged | In/Out | Vertical | Disengaged | First | Independent |
| | | | | | | Actuation | |
| | | | | | | Mechanism | |
| | | | | | | Locked; | |
| | | | | | | second | |
| | | | | | | Locked | |
| In | Horizontal | Dependently | In/Out | Vertical | Disengaged | Both | Dependent |
| | | Engaged | | | | Actuation | |
| | | | | | | Mechanisms | |
| | | | | | | Locked | |
| In/Out | Vertical | Disengaged | In | Horizontal | Dependently | Both | Dependent |
| | | | | | Engaged | Actuation | |
| | | | | | | Mechanisms | |
| | | | | | | Locked | |
| In | Horizontal | Dependently | In | Horizontal | Dependently | Both | Dependent |
| | | Engaged | | | Engaged | Actuation | |
| | | | | | | Mechanisms | |
| | | | | | | Locked | |
| In | Horizontal | Dependently | Out | Horizontal | Independently | Both | Dependent |
| | | Engaged | | | Engaged | Actuation | |
| | | | | | | Mechanisms | |
| | | | | | | Locked | |
| Out | Horizontal | Independently | In | Horizontal | Dependently | Both | Dependent |
| | | Engaged | | | Engaged | Actuation | |
| | | | | | | Mechanisms | |
| | | | | | | Locked | |

The modes of operation listed in Table 1 for the latching mechanisms 100, 200, 300 of the present invention are based, in part, on embodiments of the latching mechanism 100, 200, 300 wherein an actuation mechanism 102, 104 is engaged when the cam 122 is in a horizontal configuration such that it is in mechanical communication with the first actuation rod 106, the second actuation rod 110, or actuation levers 182, 189. The actuation mechanism 102, 104 is disengaged when the cam 122 is in a vertical configuration and out of mechanical communication with the first actuation rod 106, second actuation rod 110 or actuation levers 182, 189. However, it should be understood that the latching mechanisms 100, 200, 300 may be configured such that a cam 122 may be in mechanical communication with the first actuation rod 106, second actuation rod 110, or actuation levers 182, 189 when the cam 122 is in the vertical position and out of mechanical communication when the cam 122 is in the horizontal position. This and other suitable configurations and orientations of the cams 122 relative to the first actuation rod 106, second actuation rod 110, and actuation levers 182, 189 may also be possible to achieve the same independent/dependent locking modes listed in Table 1.

Referring now to FIGS. 9 and 10, two embodiments of the latching mechanism 100, 300 are shown installed in a container 140, in this case a storage container for use in the cargo area of a vehicle. The container 140 may have a lid portion 142 and a base portion 143. The lid portion 142 and the base portion 143 may be attached such that the container 140 has both open and closed positions. The lid portion 142 of the container 140 may have at least one latch pin 144 disposed thereon or multiple latch pins 144, 145. In the embodiment of the latching mechanism 100 shown in FIG. 9, a single latch receiving assembly 114 may be located on the interior of the base portion 143 and positioned opposite the latch pin 144 such that the latch pin 144 may be releasably retained in the latch 118 of the latch receiving assembly 114. In the embodiment of the latching mechanism 300 shown in FIG. 10, two latch receiving assemblies 114, 115 may be located on the interior of the base portion 143 with the first latch receiving assembly 114 positioned opposite the latch pin 114 and the second latch receiving assembly 115 positioned opposite the second latch pin 115. The latch receiving assemblies 114, 115 may be affixed to the container 140 using, for example, welds, adhesives, screws, nails, nuts and bolts, clamps, or any other suitable fastener or method of fastening as may be known in the art or subsequently developed.

Referring now to FIG. 9, a latching mechanism 100 according to one embodiment of the present invention is shown with the first actuation mechanism 102 and the second actuation mechanism 104 oriented in opposition to one another. The first actuation mechanism 102 may be positioned on the side of the base portion 143 while the second actuation mechanism 104 may be positioned on the opposite side of the base portion 143. Each actuation mechanism 102, 104 may be affixed to the container 140 such that the push button 120 and housing 136 of each actuation mechanism 102, 104 are positioned on the outside of the container 140 while the body 134, shaft 128, and cam 122 of each actuation mechanism 102, 104 are positioned inside the container 140. The first actuation rod 106 may extend along the inside of the base portion 102 of the container between the latch receiving assembly 114 and the first actuation 102. The first end 105 of the first actuation rod 106 may be positioned proximate the cam 122 of the first actuation mechanism 102 while the second end 107 of the first actuation rod 106 is pivotally attached to the rotor 112 of the latch receiving assembly 114. The second actuation rod 110 may extend along the inside of the base portion 104 between the latch receiving assembly 114 and the right actuation 104. The first end 108 of the second actuation rod 110 may be pivotally attached to the rotor 112 of the latch receiving assembly 114 and the second end 108 of the second actuation rod 110 may be positioned proximate the cam 122 of the second actuation mechanism. The first actuation rod 106 and the second actuation rod 110 may be supported by various support structures attached to the interior of the container, such as dividers configured with holes which the actuation rods 106, 110 pass through, clips, channels, conduits, and the like, and which allow the first actuation rod 106 and the second actuation rod 110 to slide freely between the actuations 102, 104 and the latch receiving assembly 114.

Referring now to FIG. 10, a latching mechanism 300 according to another embodiment of the present invention is shown with the first actuation mechanism 102 and the second actuation mechanism 104 oriented in parallel to one another. The first actuation mechanism 102 and the second actuation mechanism 104 may be positioned on opposite ends of the front of the base portion 143. Each actuation mechanism 102, 104 may be affixed to the container 140 such that the push button 120 and housing 136 of each actuation mechanism 102, 104 are positioned on the outside of the container 140 while the body 134, shaft 128, and cam 122 of each actuation mechanism 102, 104 are positioned inside the container 140 as well as an actuation lever 182 for each of the actuation mechanisms 102, 104. Each actuation mechanism 102, 104 may be attached to the container with clips, screws, bolts, welds, adhesives, or any other suitable method of attachment. The actuation rod 184 may extend along the inside of the base portion 143 of the container 140 between first actuation mechanism 102 and the second actuation mechanism 104 and is pivotally connected to the rotor lever 111 of the latch receiving assembly 114 and the rotor lever 151 of the second latch receiving assembly 115. The first end 183 of the actuation rod 184 may be pivotally connected to an actuation lever 182 (not shown) positioned proximate to, and in mechanical communication with, the cam 122 (not shown) of the first actuation mechanism 102. The second end 185 of the actuation rod 184 may be pivotally attached to an actuation lever 189 (not shown) positioned proximate to, and in mechanical communication with, the cam 122 (not shown) of the second actuation mechanism 104. The actuation levers 182, 189 may be pivotally attached to the interior of the container 140 in proximity to the cams 122 of the actuation mechanisms 102, 104. The actuation rod 184 may be supported by various support structures attached to the interior of the container 140, such as dividers configured with holes which the actuation rod 184 passes through, clips, channels, conduits, and the like, and which allow the actuation rod 184 move laterally between the actuations 102, 104.

It should be understood that, while the exemplary embodiment of the latching mechanisms 100, 300 shown in FIGS. 9 and 10, respectively, depict the latching mechanism 100, 300 disposed in the base portion 143 of the container 140 and the latch pins 144, 145 disposed on the lid portion 142 of the container 140, the latching mechanism 100, 300 may be disposed in the lid portion 142 of the container 140 and the latch pins 144, 145 may be disposed in the base portion 143 with both configurations having the same functionality of latching the lid portion 142 of the container 140 to the base portion 143 of the container 140.

Referring to FIGS. 9 and 10, when the container lid 142 is closed, the latch pin 144 is received in the latch 118 of the latch receiving assembly 114 and the latch pin 145 is received in the latch 152 of the second latch receiving assembly 115. To release the latch pins 144, 145 and open the container lid 142, the actuation mechanisms 102, 104 may be used to actuate the latch 118 and the latch 151 thereby releasing the latch pins 144, 145. Before the latch pins 144, 145 can be released, the push buttons 120 and cams 122 of each of the actuation mechanisms 102, 104 must be first placed in a proper configuration suitable for opening (unlocking) the latching mechanisms 100, 300. Suitable configurations for unlocking and locking the latch are shown in Table 1. As indicated, depending on the position of the push buttons and cams, the actuation mechanisms 102, 104 may be locked or unlocked and operated either dependently or independently.

While FIGS. 9 and 10 depict embodiments of the latching mechanism 100, 300 installed in a vehicle storage container, it should be understood that the latching mechanisms 100, 200, 300 of the present invention may also be used in conjunction with a variety of other containers including, without limitation, storage boxes, tool boxes, file boxes, freezers, and the like. The latching mechanism provides such containers with multiple modes of operation such that the containers may be locked or unlocked from both sides, independently, or from either side dependently.

While particular embodiments and aspects of the present invention have been illustrated and described, various other changes and modifications can be made without departing from the spirit and scope of the invention. Moreover, although various inventive aspects have been described, such aspects need not be utilized in combination. It is therefore intended that the appended claims cover all such changes and modifications that are within the scope of this invention.

What is claimed is:

1. A latching mechanism comprising:
a first actuation mechanism and a second actuation mechanism in selective communication with each another; and
at least one latch receiving assembly in selective communication with the first actuation mechanism and the second actuation mechanism, wherein the at least one latch receiving assembly is configured to receive a latch pin, and each of the first actuation mechanism and the second actuation mechanism comprise an unengaged position, an independent engaged position, and a dependent engaged position relative to the at least one latch receiving assembly;
wherein when the first actuation mechanism and the second actuation mechanisms are each in an independent engaged position, actuation of either of the first actuation mechanism or second actuation mechanism causes a rotor in association with the at least one latch receiving assembly to rotate thereby releasing the latch pin; and
wherein when both the first actuation mechanism and the second actuation mechanism are in an unengaged position, neither the first actuation mechanism or the second actuation mechanism can be actuated so as to cause the rotor in association with the at least one latch receiving assembly to rotate thereby releasing the latch pin; and
wherein when either one of the first actuation mechanism or the second actuation mechanism is in an independent engaged position and the other actuation mechanism is in an unengaged position, actuating the actuation mechanism in the independent engaged position causes the rotor in association with the at least one latch receiving assembly to rotate thereby releasing the latch pin; and
wherein when one of the first actuation mechanism and the second actuation mechanism is in a dependent engaged position, neither the first actuation mechanism or the second actuation mechanism can be actuated so as to cause the rotor in association with the at least one latch receiving assembly thereby releasing the latch pin.

2. The latching mechanism of claim 1 wherein the first actuation mechanism and the second actuation mechanism are configured in parallel.

3. The latching mechanism of claim 1 wherein the first actuation mechanism and the second actuation mechanism are configured in series.

4. The latching mechanism of claim 1 wherein the first actuation mechanism and the second actuation mechanism and the at least one latch receiving assembly are in selective communication with each other via at least one actuation rod.

5. The latching mechanism of claim 1 wherein the independently engaged position, dependently engaged position, and unengaged positions are selected by positioning a first cam operatively attached to the first actuation mechanism and a second cam operatively attached to the second actuation mechanism relative to the at least one latch receiving assembly.

6. The latching mechanism of claim 1 further comprising a latch pin wherein the first actuation mechanism, second actuation mechanism, and the at least one latch receiving assembly are attached to a first portion of a container and the latch pin is attached to a second portion of the container such that the latch pin may be releasably received by the at least one latch receiving mechanism thereby latching the first portion of the container to the second portion of the container.

7. A latching mechanism comprising:
a first actuation mechanism comprising a first cam, the first cam being extendable, retractable and rotatable relative to the first actuation mechanism and a second actuation mechanism comprising a second cam, the second cam being extendable, retractable and rotatable relative to the second actuation mechanism, the first actuation mechanism and the second actuation mechanism oriented in opposition to each other;
at least one latch receiving assembly for releasably receiving a latch pin, the at least one latch receiving assembly comprising a rotor for actuating the at least one latch receiving assembly;
wherein the at least one latch receiving assembly is disposed between the first actuation mechanism and the second actuation mechanism;
the first actuation mechanism is in mechanical communication with the at least one latch receiving assembly via a first actuation rod, a first end of the first actuation rod positioned in proximity to the first cam and a second end of the first actuation rod in pivotal communication with the rotor;
the second actuation mechanism in mechanical communication with the at least one latch receiving assembly via an second actuation rod, a first end of the second actuation rod in pivotal communication with the rotor and a second end of the second actuation rod positioned proximate the second cam;
wherein the motion of either the first actuation rod or the second actuation rod towards the at least one latch receiving assembly actuates the at least one latch receiving assembly; and
wherein the first cam and the second cam may be positioned relative to the first actuation rod and the second actuation rod, respectively, to facilitate modes of operation of the first actuation mechanism and the second actuation mechanism of the latching mechanism.

8. The latching mechanism of claim 7 wherein the first actuation mechanism and the second actuation mechanism may be operated in either independent modes or dependent modes.

9. The latching mechanism of claim 8 wherein in a dependent mode of operation both the first actuation mechanism and second actuation mechanism are locked when either the first actuation mechanism or the second actuation mechanism is locked.

10. The latching mechanism of claim 8 wherein in an independent mode of operation the first actuation mechanism and the second actuation mechanism are locked or unlocked independent of one another and either the first actuation mechanism, the second actuation mechanism, or both may be used to actuate the latching mechanism.

11. The latching mechanism of claim 8 wherein in an independent mode of operation the first cam is positioned relative to the first actuation rod and the second cam is positioned relative to the second actuation rod such that the first actuation mechanism may be locked or unlocked independent of the second actuation mechanism and the second actuation mechanism may be locked or unlocked independent of the first actuation mechanism and either the first actuation mechanism, the second actuation mechanism, or both may be used to actuate the latching mechanism.

12. The latching mechanism of claim 8 wherein in a dependent mode of operation at least one of the first cam and second cam is positioned so as to prevent the first actuation rod and the second actuation rod from actuating the at least one latch receiving assembly.

13. The latching mechanism of claim 7 wherein the second actuation rod has at least two jogs located between the first end and second end such that the first end of the second actuation rod is offset from the second end of the second actuation rod.

14. The latching mechanism of claim 7 further comprising a latch pin wherein the first actuation mechanism, second actuation mechanism, and the at least one latch receiving assembly are attached to a first portion of a container and the latch pin is attached to a second portion of the container such that the latch pin may be releasably received by the at least one latch receiving mechanism thereby latching the first portion of the container to the second portion of the container.

15. A latching mechanism comprising:
a first actuation mechanism comprising a first cam, the first cam being extendable, retractable and rotatable relative to the first actuation mechanism and a second actuation mechanism comprising a second cam, the second cam being extendable, retractable and rotatable relative to the second actuation mechanism, the first actuation mechanism and the second actuation mechanism oriented in parallel to each other;
at least one latch receiving assembly for releasably receiving a latch pin, the at least one latch receiving assembly comprising a rotor for actuating the at least one latch receiving assembly; and
an actuation rod;
wherein:
the actuation rod is pivotally attached to the rotor of the at least on latch receiving assembly such that the at least one latch receiving assembly is in mechanical communication with the actuation rod;
the first cam is positioned proximate to a first actuation lever in mechanical communication with the actuation rod, the first actuation lever for imparting motion to the actuation rod; and
the second cam is positioned proximate to a second actuation lever in mechanical communication with the actuation rod, the second actuation lever for imparting motion to the actuation rod;
wherein the motion of the actuation rod actuates the at least one latch receiving assembly; and
wherein the first cam and the second cam may be positioned relative to the first actuation lever and the second actuation lever, respectively, to facilitate modes of operation of the first actuation mechanism and the second actuation mechanism of the latching mechanism.

16. The latching mechanism of claim 15 wherein the first actuation mechanism and the second actuation mechanism may be operated in either independent modes or dependent modes.

17. The latching mechanism of claim 16 wherein in a dependent mode of operation both the first actuation mechanism and second actuation mechanism are locked when either the first actuation mechanism or the second actuation mechanism is locked.

18. The latching mechanism of claim 16 wherein in an independent mode of operation the first actuation mechanism and the second actuation mechanism are locked or unlocked independent of one another and either the first actuation mechanism, the second actuation mechanism, or both may be used to actuate the latching mechanism.

19. The latching mechanism of claim 16 wherein in an independent mode of operation the first cam is positioned relative to the first actuation rod and the second cam is positioned relative to the second actuation rod such that the first actuation mechanism may be locked or unlocked independent of the second actuation mechanism and the second actuation mechanism may be locked or unlocked independent of the first actuation mechanism and either the first actuation mechanism, the second actuation mechanism, or both may be used to actuate the latching mechanism.

20. The latching mechanism of claim 16 wherein in a dependent mode of operation at least one of the first cam and the second cam is positioned so as to prevent the first actuation rod and the second actuation rod from actuating the at least one latch receiving assembly.

21. The latching mechanism of claim 15 further comprising a latch pin wherein the first actuation mechanism, second actuation mechanism, and the at least one latch receiving assembly are attached to a first portion of a container and the latch pin is attached to a second portion of the container such that the latch pin may be releasably received by the at least one latch receiving mechanism thereby latching the first portion of the container to the second portion of the container.

22. A storage container comprising a first portion and a second portion, the first portion comprising a latch mechanism and the second portion comprising at least one latch pin, the first portion and the second portion attached to each other such that the storage container has an open position and a closed position, wherein the latch mechanism of the first portion comprises:
a first actuation mechanism and a second actuation mechanism in selective communication with each another; and
at least one latch receiving assembly in selective communication with the first actuation mechanism and the second actuation mechanism, wherein the at least one latch receiving assembly is configured to receive a latch pin, and each of the first actuation mechanism and the second actuation mechanism comprise an unengaged position, an independent engaged position, and a dependent engaged position relative to the at least one latch receiving assembly;
wherein when the first actuation mechanism and the second actuation mechanisms are each in an independent engaged position, actuation of either of the first actuation mechanism or second actuation mechanism causes a rotor in association with the at least one latch receiving assembly to rotate thereby releasing the latch pin; and
wherein when both the first actuation mechanism and the second actuation mechanism are in an unengaged position, neither the first actuation mechanism or the second actuation mechanism can be actuated so as to cause the rotor in association with the at least one latch receiving assembly to rotate thereby releasing the latch pin; and
wherein when either one of the first actuation mechanism or the second actuation mechanism is in an independent engaged position and the other actuation mechanism is in an unengaged position, actuating the actuation mechanism in the independent engaged position causes the rotor in association with the at least one latch receiving assembly to rotate thereby releasing the latch pin; and
wherein when one of the first actuation mechanism and the second actuation mechanism is in a dependent engaged position, neither the first actuation mechanism or the second actuation mechanism can be actuated so as to cause the rotor in association with the at least one latch receiving assembly thereby releasing the latch pin; and
wherein when the storage container is in the closed position, the at least one latch pin is releasably received by the at least one latch receiving mechanism such that the first portion of the container is latched to the second portion of the container.

23. The latching mechanism of claim 22 wherein the first actuation mechanism and the second actuation mechanism and the at least one latch receiving assembly are in selective communication with each other via at least one actuation rod.

24. The latching mechanism of claim 22 wherein the independently engaged position, dependently engaged position, and unengaged positions are selected by positioning a first cam operatively attached to the first actuation mechanism and/or a second cam operatively attached to the second actuation mechanism relative to the at least on latch receiving assembly.
